(19) United States
(12) Patent Application Publication
(10) Pub. No.: US 2026/0364513 A1
(43) Pub. Date: Nov. 19, 2026

(54) NOX REDUCTION IN A VEHICLE INTERIOR

(71) Applicant: AUDI AG, Ingolstadt (DE)

(72) Inventors: Simone MÜLLER-HELLWIG, Ingolstadt (DE); Hagen SEIFERT, München (DE); Alexander KRAJETE, Pasching (AT); Bodo WILKE, Hitzhofen (DE)

(73) Assignee: AUDI AG, Ingolstadt (DE)

(21) Appl. No.: 19/103,253

(22) PCT Filed: Oct. 26, 2023
(86) PCT No.: PCT/EP2023/079984

§ 371 Date: Feb. 12, 2025

(30) Foreign Application Priority Data
Nov. 9, 2022 (DE) 10 2022 129 539.7

(51) Int. Cl. B01D 53/04; B01D 46/00; B60H 3/06

(52) U.S. Cl. CPC B01D 53/0446; B01D 46/0036; B01D 53/0454; B60H 3/0608; B01D 2253/108; B01D 2257/404; B01D 2258/06; B01D 2259/4566; B01D 2273/30; B01D 2279/40

(57) ABSTRACT

A filter unit for removing nitrogen oxides from air, an arrangement for reducing the nitrogen oxide content of the air in a closed space, a motor vehicle with the arrangement and a method for removing nitrogen oxides from the air in a closed space.

### FIELD

The invention relates to a filter unit for removing nitrogen oxides from air, an arrangement for reducing the nitrogen oxide content of the air in a closed space, a motor vehicle comprising the arrangement and a method for removing nitrogen oxides from the air in a closed space.

### BACKGROUND

Currently, there are only very limited options for reducing exhaust gas components in the vehicle interior, for example those coming from vehicles driving ahead. One possibility is the “recirculation setting” on the air conditioning system. This prevents a lot of air from being sucked in from outside. Another option is to use the HEPA/activated carbon filters that are already installed in some vehicles. However, both technical solutions can only be used to a limited extent for NOₓ reduction.

The disadvantage of the “recirculation setting” is that pollutants such as CO₂ and NOₓ accumulate very quickly in the interior air, so this is only a very time-limited measure. In addition, the humidity also increases rapidly. HEPA filters in combination with activated carbon filters do have a filtering effect, but many filters have only a very limited capacity and the loaded filters must be replaced; the loaded material cannot be recycled.

DE 198 38 996 A1 relates to an air conditioning system with an activated carbon filter for cleaning the air supplied to the interior of a motor vehicle. A device is provided for cleaning by heating the filter and the air in it, and the air contaminated with waste products can be driven out of the filter by means of a cleaning air stream, the activated carbon being in contact with a temperature-controlled or temperature-regulated heater, with which the activated carbon and the air in the filter are heated while the cleaning air stream flows through the filter.

DE 38 19 002 A1 describes a filter for removing odors and pollutants that enter vehicle cabins via the ventilation system. The filter material is designed as a cassette that is inserted into the air flow of the ventilation system and can be easily replaced. It consists of a carrier material made of PU foam, to the outer and inner surface of which adsorbent particles made of polymer material are fixed by means of an adhesive mass.

DE 10 2017 201 367 A1 discloses a device for cleaning air loaded with CO₂ in a closed room, which device comprises an adsorption device for adsorbing CO₂ from the air supplied to the adsorption device, a desorption device associated with the adsorption device for desorbing adsorbed CO₂, and a discharge device for discharging the desorbed CO₂.

DE 10 2018 000 378 A1 relates to a system and a method for recycling of nitrogen oxides formed in combustion engines, with which the nitrogen oxides can be used to produce liquid or solid chemicals.

### SUMMARY

Against this background, the invention has set itself the task of providing devices and methods with which nitrogen oxides can be removed from interior air and the removed nitrogen oxides can later be recycled.

The invention relates to a filter unit for removing nitrogen oxides from the air in a closed space (interior air). The filter unit comprises a closed housing which has a pipe at one end for introducing air into the filter unit and a pipe at an opposite end for discharging air from the filter unit, with fans arranged in each of the pipes. The pipes are each connected to a pressure chamber in the housing. Between the pressure chambers, at least two granulate chambers are arranged, which contain adsorbent granulate capable of adsorbing nitrogen oxides. The at least two granulate chambers are each separated from each other by an intermediate insert or filter insert.

In one embodiment, the closed space is a vehicle interior, in particular a passenger cell. In another embodiment, the enclosed space is a room within a building, such as a living room or a garage.

In one embodiment, the housing has the shape of a closed cylinder. The pipes for introducing air into the filter unit and for discharging air from the filter unit can be arranged radially or axially on the housing. The fans can selectively operate in suction or pressure mode.

The filter unit comprises at least two granulate chambers. In one embodiment, the filter unit comprises three granulate chambers. The number of granulate chambers in the filter unit and the division of the internal volume of the filter unit can vary depending on the area of application. The presence of several granulate chambers within the filter unit allows different adsorbent granulates to be provided in one filter unit. The adsorbent granulates can differ from one another in their grain size and/or chemical composition.

In one embodiment, the adsorbent granulate comprise at least one zeolite. Zeolites that can adsorb nitrogen oxides are known in principle to those skilled in the art. Examples comprise ZSM-5, zeolite Y and mordenite.

In another embodiment, the adsorbent granulate comprises alkali oxides or alkaline earth oxides or alkali carbonates or alkaline earth carbonates, optionally on a granular carrier material. In a special embodiment, the adsorbent granulate comprises barium oxide, optionally in combination with platinum and rhodium.

The filter unit according to the invention is filled with adsorbent granulate, which can be easily replaced and recycled. The filter unit can be used both to filter fresh air supplied to the interior and to filter the interior air and is placed accordingly in the air supply or in the interior. By using the filter unit, a permanent reduction of the NOₓ concentration in the interior can be achieved.

In one embodiment, the filter unit and/or the adsorbent granulate are intended to be replaced and reprocessed after use. The adsorbent granulate can be easily removed and replaced, for example when the filter unit is saturated with NOₓ. The granulate can be recycled by separating the NOₓ molecules from the granulate, for example by heat. The resulting NOₓ gas stream is captured and fed into conversion processes.

In one embodiment, the filter unit is portable so that it can be used variably in different interiors. For example, it could be used either in the interior of a vehicle or in a building.

The invention also relates to an arrangement for reducing the nitrogen oxide content (NOₓ content) of the air in a closed space, comprising a supply system for ambient air in the closed space and/or a recirculation system for circulating air in the closed space, wherein the supply system and/or the recirculation system comprise a nitrogen oxide filter for reducing the nitrogen oxide content of the supplied ambient air. According to the invention, at least one nitrogen oxide filter comprises a filter unit according to the invention with an adsorbent granulate for NOₓ.

In one embodiment, the arrangement comprises both a supply system for ambient air in the closed space and a recirculation system for circulating air present in the closed space. In a further embodiment, both the supply system and the recirculation system comprise a filter unit according to the invention.

In one embodiment, the closed space is a vehicle interior, in particular a passenger compartment. In another embodiment, the enclosed space is a room within a building, such as a living room or a garage.

The invention also relates to a motor vehicle with an interior and an air conditioning system for the interior, wherein the air conditioning system comprises an arrangement according to the invention.

In one embodiment, the motor vehicle comprises an arrangement according to the invention with two filter units, namely a first filter unit (fresh air filter), which is arranged in a leaf catcher or in a water tank of the motor vehicle and filters air sucked into the motor vehicle before it enters the air conditioning system, and a second filter unit (interior filter), which is arranged in a passenger compartment of the motor vehicle and filters the interior air.

In one embodiment, the motor vehicle comprises control electronics, which are also intended to control the arrangement according to the invention. In a further embodiment, the filter units can be controlled separately by means of a software application (“app”). In one embodiment, the app is installed on a user's mobile device, such as a laptop, tablet or smartphone. In another embodiment, the app is part of a user interface of the on-board electronics of the motor vehicle.

The invention also relates to a method for removing nitrogen oxides from the air in a closed space, in which ambient air is passed through at least one filter unit according to the invention and then fed to the closed space. In one embodiment of the method, the ambient air is outside air which is to be supplied to the closed room. In one embodiment of the method, the ambient air is air present in the closed space. In one embodiment of the method, both the outside air to be supplied to the closed space and the air in the closed space are each passed through a filter unit according to the invention.

In one embodiment, the closed space is a vehicle interior, in particular a passenger compartment. In another embodiment, the enclosed space is a room within a building, such as a living room or a garage.

By using the arrangement according to the invention, good and fresh air is permanently generated for the occupants of the vehicle. The adsorbent granulate used in the cartridges can be easily removed and replaced after saturation with NOₓ. The granulate can be recycled and the desorbed NOₓ can be recycled for other uses. Further advantages and embodiments of the invention will be apparent from the description and the accompanying drawing.

It is apparent that the above-mentioned features and the features still to be explained hereinafter are usable not only in the particular specified combination but rather also in other combinations or alone, without leaving the scope of the present invention.

### BRIEF DESCRIPTION OF THE FIGURES

The invention is schematically illustrated in the figures with reference to an embodiment and is described further with reference to the figures. In the figures:

FIG. 1 shows a schematic representation of a motor vehicle with an embodiment of the interior air cleaning according to the invention.

FIG. 2 a diagram of measured nitrogen oxide levels during a test drive of the motor vehicle from FIG. 1;

FIG. 3 shows a schematic representation of an embodiment of a filter unit according to the invention.

### DETAILED DESCRIPTION

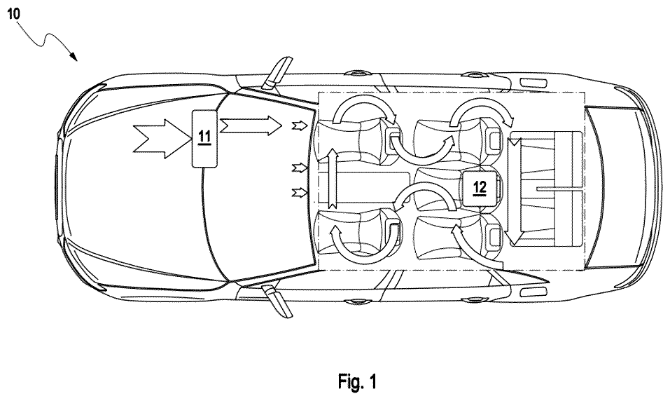

FIG. 1 shows a motor vehicle 10 with an embodiment of the arrangement according to the invention for interior air cleaning. Two filter cartridges 11, 12 are used, a fresh air filter 11, which is arranged, for example, in the leaf catcher or in the water tank of the motor vehicle, and an interior filter 12, which is arranged in the passenger compartment, for example in the region of the rear seats.

In the fresh air filter 11, the intake air is continuously filtered before entering the air conditioning system by one or more adsorbing filter granulates (500-2000 ml), which specifically retain(s) NOₓ molecules. When the granulate is passed through once, approximately 95% of the nitrogen oxides are removed from the air.

In the interior filter 12, the interior air is continuously filtered by one or more adsorbing filter granulates (1000-2000 ml). The interior air is filtered several times through the granulate, the total NOₓ absorption rate is approx. 90%. The interior filter can be permanently mounted or removable so that it can be transported when leaving the vehicle and used in a home environment.

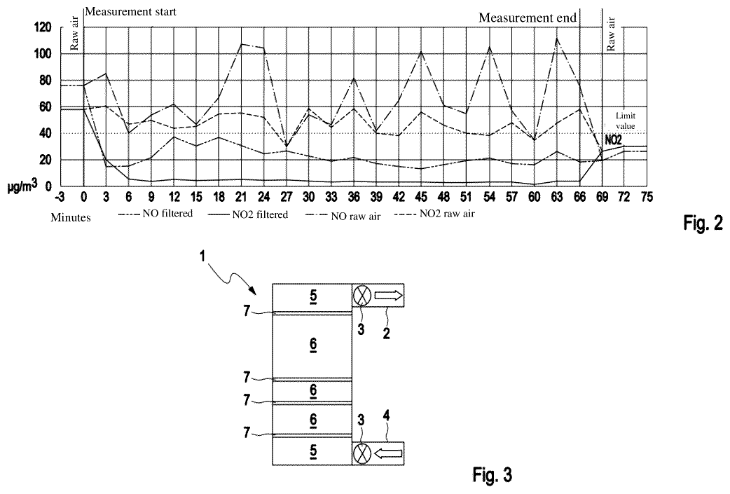

FIG. 2 shows the results of nitrogen oxide measurements carried out during a test drive with the motor vehicle shown in FIG. 1. It is clearly visible that the limit values for NO₂ in the outside air (raw air) supplied to the vehicle are largely exceeded in the area of the test drive. The load on the vehicle occupants would be constantly very high. By using the fresh air filter 11 arranged in the leaf catcher and the interior filter 12 arranged in the interior, the NO₂ load is considerably reduced. With the use of the interior filter 12, the NO load is also noticeably reduced. This means that significantly less new NO₂ can form in the vehicle interior.

FIG. 3 shows schematically the structure of an embodiment of the filter unit 1 according to the invention. The cylindrical housing of the filter unit 1 has at its one longitudinal end an air inlet 4 for air containing pollutants, which can be arranged radially or axially. A fan 3 is arranged in the air inlet 4, which fan can be used variably in suction or pressure operation mode. At the other longitudinal end of the housing, an air outlet 2 for cleaned air is provided, which can also be arranged radially or axially. A fan 3 is also arranged in the air outlet 2, which fan can be used variably in suction or pressure operation mode.

Inside, the filter unit 1 has a respective pressure chamber 5 at both ends, which serves to homogenize the air entering or leaving the filter unit 1 and ensures a uniform gas flow over the entire cross-section of the filter unit 1. The filter unit 1 shown has three granulate chambers 6, which are separated from each other or from the pressure chambers 5 by filter inserts 7. In one embodiment, the filter inserts 7 are stainless steel or wire sieves, in another embodiment they are plastic sieves. The filter inserts 7 have a mesh size that is smaller than the particle diameter of the granulate particles in the granulate chambers 6. The filter inserts 7 prevent the granulates from the different granulate chambers 6 from mixing. The number of granulate chambers 6 and the division within the filter unit 1 can be varied depending on the application.

### LIST OF REFERENCE NUMERALS

1 filter unit with housing
2 filter air outlet
3 fans
4 inlet polluted air
5 pressure chamber
6 granulate chamber
7 intermediate insert/filter insert
10 motor vehicle
11 cartridge
12 interior filter

1-10. (canceled)

11. A filter unit with a closed housing, which has a pipe at one end for introducing air into the filter unit and a pipe at an opposite end for discharging air from the filter unit, wherein fans are arranged in each of the pipes, and wherein the pipes are each connected to a pressure chamber in the housing, and wherein at least two granulate chambers are arranged between the pressure chambers, which granulate chambers contain adsorbent granulate capable of adsorbing nitrogen oxides, and wherein the at least two granulate chambers are each separated from one another by an intermediate insert/filter insert.

12. The filter unit according to claim 11, wherein the housing has the shape of a closed cylinder and the pipes are arranged radially on the housing.

13. The filter unit according to claim 11, wherein the housing has the shape of a closed cylinder and the pipes are arranged axially on the housing.

14. The filter unit according to claim 11, wherein the adsorbent granulate comprises at least one zeolite.

15. The filter unit according to claim 11, wherein the filter unit and/or the adsorbent granulate are intended to be replaced and reprocessed after use.

16. An arrangement for reducing the nitrogen oxide content of the air in a closed space, comprising a supply system for ambient air in the closed space and/or a recirculation system for circulating air in the closed space, wherein the supply system and/or the recirculation system comprise a nitrogen oxide filter for reducing the nitrogen oxide content of supplied ambient air, wherein at least one nitrogen oxide filter comprises a filter unit according to claim 11.

17. A motor vehicle with an interior and an air conditioning system for the interior, which comprises an arrangement according to claim 16.

18. The motor vehicle according to claim 17, wherein the arrangement comprises a first filter unit which is arranged in a leaf catcher or in a water tank of the motor vehicle and filters air sucked into the motor vehicle before entering the air conditioning system, and a second filter unit which is arranged in a passenger compartment of the motor vehicle and filters the interior air.

19. The motor vehicle according to claim 17, further comprising control electronics which are adapted to control the arrangement.

20. A method for removing nitrogen oxides from the air in a closed space, in which ambient air is passed through at least one filter unit according to claim 11 and then supplied to the closed space.

21. The filter unit according to claim 12, wherein the adsorbent granulate comprises at least one zeolite.

22. The filter unit according to claim 13, wherein the adsorbent granulate comprises at least one zeolite.

23. The filter unit according to claim 12, wherein the filter unit and/or the adsorbent granulate are intended to be replaced and reprocessed after use.

24. The filter unit according to claim 13, wherein the filter unit and/or the adsorbent granulate are intended to be replaced and reprocessed after use.

25. The filter unit according to claim 14, wherein the filter unit and/or the adsorbent granulate are intended to be replaced and reprocessed after use.

26. The motor vehicle according to claim 18, further comprising control electronics which are adapted to control the arrangement.
